(19) United States
(12) Patent Application Publication
(10) Pub. No.: US 2015/0032606 A1
(43) Pub. Date: Jan. 29, 2015

(54) SYSTEM FOR PERFORMING SECURE LARGE MONETARY TRANSACTIONS THROUGH MOBILE COMMUNICATION DEVICES

(71) Applicant: Sylvain BERTOLUS, Lausanne (CH)

(72) Inventor: Sylvain BERTOLUS, Lausanne (CH)

(21) Appl. No.: 14/339,592

(22) Filed: Jul. 24, 2014

Related U.S. Application Data
(60) Provisional application No. 61/858,162, filed on Jul. 25, 2013.

(51) Int. Cl. G06Q 20/32; G06Q 20/38

(52) U.S. Cl. CPC G06Q 20/3278; G06Q 20/389
USPC 705/39

(57) ABSTRACT

A computerized system and associated process for securing large monetary transactions through mobile phones or smartphones. The system offers several security innovations bringing the trust and safety expected when handling such important transactions.

This application claims the benefit of United States provisional application Ser. No. 61/858,162 filed Jul. 25, 2013.

### FIELD OF THE INVENTION

The invention provides a computerized system and associated processes for securing large monetary transactions through mobile phones or smartphones. The system offers several security innovations bringing the trust and safety expected when handling such important transactions.

### TECHNICAL FIELD

The present invention relates to the general field of payment processing, and more particularly to the technical field of transaction security features through a method for safely allowing individual or businesses to conduct large monetary transactions (typically between $1,000 and $100,000) while being away from their home or typical place of business, over mobile phones or smartphones.

In the last few years, most actors of the financial services industry have been focusing on providing mobile payments to the general public as means to replace their wallet by what is known as “electronic wallets.”

In such instances, the intent is for customers to use their mobile phones in their everyday transactions, when buying consumer goods (e.g., coffee, groceries, gas, etc.). The typical amount per transaction is up to $1,000; actual limits vary by country and provider but are consistently designed as low since customers of such systems are expected to need and use the system several times throughout the day or week.

Such systems are designed to offer a minimum of transaction security, in order not to affect the ease of use for consumers. Typically, the user experience is reduced to a strict minimum so as to not discourage them from reverting to conventional payment means such as cash and credit or debit cards which are arguably easier and faster to use for small payments (typically under $1,000).

The present invention takes a different approach by bringing enough security features to enable the use of mobile phones or smartphone while performing larger monetary transactions. Consumers are not typically expected to conduct such large transactions as often as when buying everyday consumer goods; therefore the relatively small additional burden brought by these new security features are expected to be of small annoyance compared to the existing means of conducting such large transactions with other payment means.

Existing payments means allowing payments between $1,000 and $100,000 are:
Physical cash;
Checks;
Bank wires;
Under some conditions, credit cards.

The invention brings a means to proceed with transactions in the aforementioned price range between private individuals as well as with professionals, with the following advantages:
Instantaneity. The system is designed to ensure that the transaction can take place directly when ordered by the buyer;
No geographical or time limitations. The system is designed to ensure that the transaction can take place as long as buyer and seller have cellular network coverage.
Non-repudiation. The system is designed to ensure that buyer and seller cannot repudiate the transaction;
Counterparty authentication. The system is designed to bring to all parties sufficient proof that they are dealing with the expected counterparty.

The first two features (instantaneity and lack of geographical or time limitations) are mostly inherent to the underlying technology of mobile phones and procedural efficiency. The invention brings technical novelty through the last two features (Non-repudiation and Counterparty authentication), providing to consumers a new way to safely perform large, on-the-spot and on-the-go transactions.

### PRIOR ART AND THE PROBLEM UNDERLYING THE INVENTION

Most prior art is geared towards the invention of universal electronic wallet systems. They therefore provide means to conduct multiple transactions over a variety of means made available on mobile phones, such as SMS or data connections. Such systems offer some basic non-repudiation, usually by requesting users to send back a random code (OTP) to the service operator. However anyone with access to the mobile device could perform this operation.

Some also offer counterparty authentication through the use of a Personal

Identification number (PIN) or Transaction Authentication Numbers (TAN). However, the security of these mechanisms is controversial, as the channels used to convey them are typically not secure (in the case of using a PIN via SMS), or require the bearer to carry the list of TANs on him/her, together with the mobile device. Besides, most cell phones retain SMS messages in a memory, further reducing the security of a single PIN to authorize multiple transactions.

The US Patent No. WO 2007/083319 A2 discloses a method and system for making a payment through a mobile communication device. According to the disclosed invention, payments are secured by requesting a PIN from the payer. This mechanism offers very basic non-repudiation which can easily be challenged by the customer. The mechanism also does not offer appropriate counterparty authentication, as there is no requirement for parties to the transaction to communicate physically in order for the process to go through.

The U.S. Patent Publication No. US 2011/0196783 A1 discloses a wireless payment platform and mobile reseller system. According to the disclosed invention, payments are triggered thanks to a system of unilateral verification of payment information between the service-provider's server and the party's mobile phone. However, this invention does not provide any particular mechanism to provide sufficient non-repudiation and counterparty authentication.

The U.S. Patent Publication No. US 2012/0054102 A1 discloses a method & system for providing payments over a wireless connection. According to the disclosed invention, payment transactions are validated through generation of “an IVR callback” to provide confirmation. This mechanism requests the payer to confirm his/her intention by sending back to the service provider a confirmation code. This basic mechanism does not provide sufficient non-repudiation and counterparty authentication.

The U.S. Pat. No. 7,089,208 B1 discloses a system and method for facilitating a value exchange transaction. According to the disclosed invention, users can receive values before having been enrolled in the system. This typically would not be possible in the case of an instantaneous large money transfer, as the second user is not yet known to the system-provider; therefore preventing the system-provider from asserting with certainty that said user is in agreement with the sale, nor that he/she is compliant in terms of Anti-Money Laundering background checks. Another embodiment of the invention presents an escrow system by which the system puts the value of the transaction in escrow and may require that both parties agree before the funds are transferred; however the mechanism for such agreement is not disclosed.

The disclosed invention is, therefore, geared towards one-way payments by which the recipient does not need to systematically show agreement and subject himself to a procedure that brings authentication and non-repudiation as well as instantaneity and geographical freedom.

### SUMMARY OF THE INVENTION

The present invention provides a method for safely allowing instantaneous, large monetary transactions over mobile phones and smartphones, between private individuals and between private individuals and merchants.

Therefore it is a first objective of the present invention to bring sufficient security features to allow such a transaction to be performed safely by all parties.

A second objective is to provide such security features over a variety of existing technologies in order to enable consumers to perform transactions regardless of which mobile device or smartphone they are using.

The third objective is to ensure that all necessary controls are performed before users instruct the transaction, so as not to introduce any delay if and when users provide the instruction to perform the transaction.

To achieve the first objective mentioned above, the invention introduces a transaction verification mechanism referred to as the “One-Time-Password-swap” (“OTP-swap”). The OTP-swap brings the non-repudiation and counterparty authentication features required to secure the transaction.

To achieve the second objective, the invention introduces a device- and technology-independent transaction engine and process, which can function over disconnected and non-secured communication channels such as Short Message Service (“SMS”) or connected, secured channels such as a data connection between a connected phone (“Smartphone”) and a transaction engine residing on a server operated by the service provider.

To achieve the third objective, the invention introduces a business process in which user registration and typical controls for large transactions such as Anti-Money-Laundering (“AML”) are performed before the transaction actually takes place. FIG. 1 depicts the major steps of this process.

The system therefore allows the safe transfer of funds in escrow with either the company offering the service or the client's bank, using conventional electronic money transfers as offered by Banks. It guarantees the ability to execute the transaction at the payer's request, since all checks typically blocking such transactions are performed beforehand.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 represents a general overview of the process;

Fig, 2 represents the transaction mechanism, including the OTP-Swap feature; and

FIG. 3 depicts the technical architecture of an implementation of the preferred embodiment.

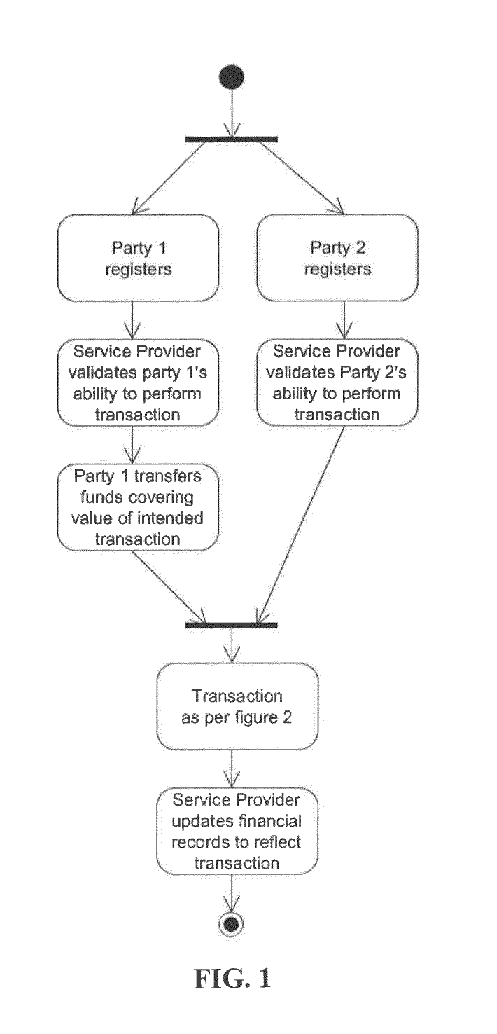

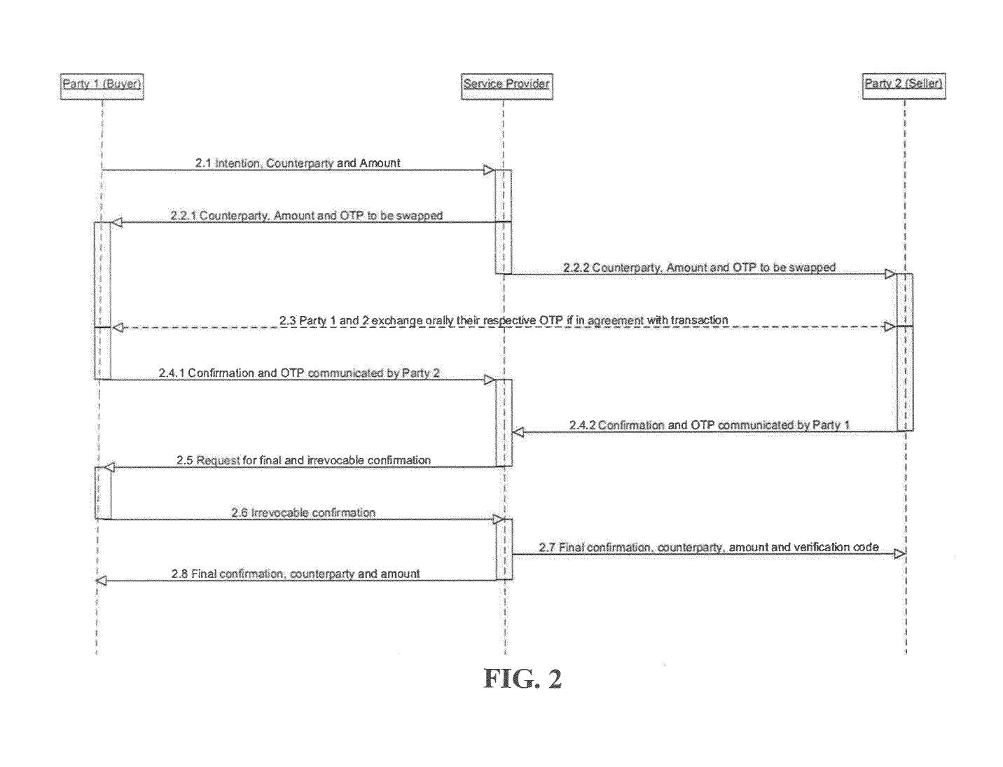

### DETAILED DESCRIPTION OF THE PREFERRED EMBODIMENT

The following description is presented to enable any person skilled in the art to make and use the invention, and is provided in the context of particular applications of the invention. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The program environment in which a present embodiment of the invention is executed illustratively incorporates server computers being operated by the service-provider as well as SMS-capable cellular phones, or smartphones on the user-side (parties to the transaction). Technical details of such devices (e.g., processor, memory, data storage, display, wired/wireless communication capability) are omitted as they are not directly relevant to the invention.

### Introduction

According to one embodiment of the invention, a system and a method are provided by a service-provider through a server system, enabling two users to safely make an instantaneous large payment by using SMS-capable cellular phones or smartphones.

In the preferred embodiment users need to be equipped with a cellular phone or a smartphone running a software provided by the service-provider. What specific equipment each party to a transaction use is not relevant to the ability of executing the transaction.

We define large payments as the transfer of a significant amount of money from one person to the other, such as amounts in excess of $1,000.

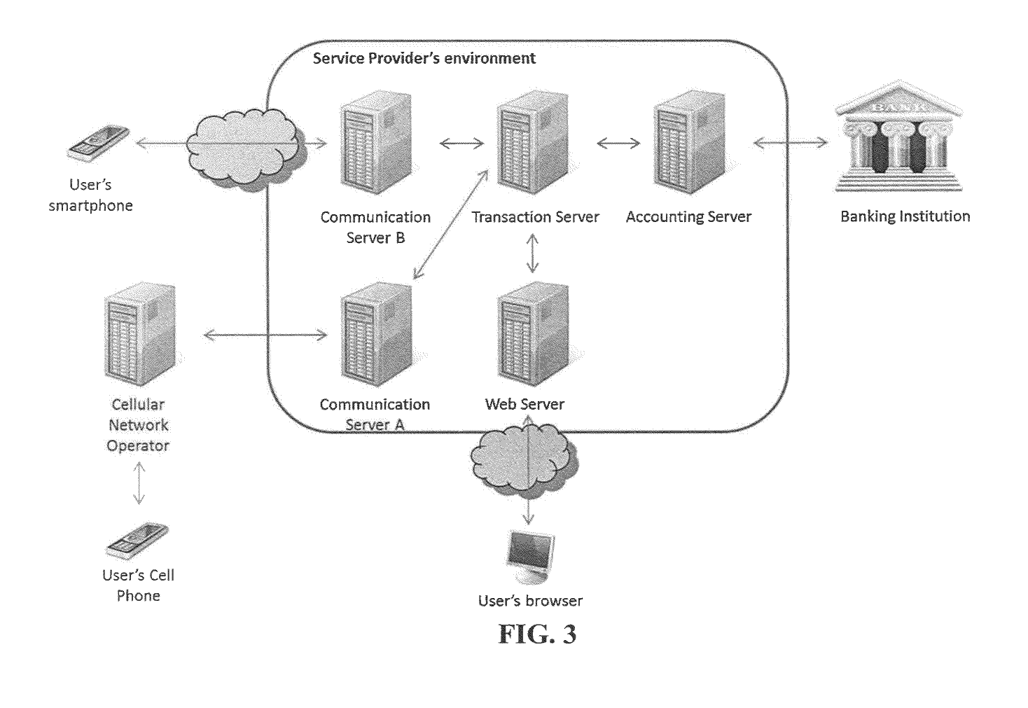

In the preferred embodiment, the service-provider runs the system on a collection of servers which offer a collection of functions detailed below. FIG. 3 depicts the technical architecture of the preferred embodiment.

### Functions Provided by the Service-provider to Parties Through Server Computers

In a preferred embodiment, the parties to the transaction are provided with a secured web interface by a Web server, through the use of a certificate and of SSL (Secured Socket Layer). The interface allow them to open their account by filling out a webpage which requests all required information to satisfy the background checks run by the provider. The information varies depending on the country of residence of the party, based on legal requirements. It typically includes first name and last name, street address, date of birth, country of citizenship, a copy of an ID card or passport, and acceptance of the service terms and conditions.

Another webpage is offered to the parties to the transaction to allow them to verify the status and the balance of their account, as well as the details of their last few account movements and transactions.

Yet another webpage allows the parties to request actions from the service-provider, such as to return the funds currently held in escrow by the service-provider, to close the account, or ask for an amendment of their personal information.

A communication server A establishes connectivity to cellular network operators, in order to receive and send SMS messages from the parties. That server is interconnected to the main transaction and accounting server. It executes a program that interprets the messages sent by users of the cellular network and attempts to put them in context of the information held on the transaction and accounting server. In case the program identifies that the message is part of a new or on-going transaction, it communicates to the transaction and accounting server the information received, specifically the parties to the transaction, the transaction amount and the step taken by the communicating party in our transaction process.

A communication server B provides direct connectivity to smartphones, via SSL-secured, direct connections over the Internet. It runs a program that manages the connectivity and security of communications with the parties' smartphones. Parties using smartphones need to download and run software made available by the service-provider.

When the software is run for the first time, the software on the smartphone prompts the party for his/her credentials. Upon verification with the server, a unique identifier derived from the smartphone and user combination is calculated and stored server-side.

Upon further connections, the software running on the device and the server compare the unique identifier to ensure that the device is an expected device, associated to the expected user for that device.

Once these security considerations are taken care of, the program on the server handles messages sent by the software on the smartphone, and relays the information received to the transaction and accounting server.

A transaction server runs a program (subsequently called the transaction engine) built to be independent of the communication server used to relay the party's message. It runs a state machine program that represents, for each on-going transaction, the current state of the transaction. It advances transactions based on latest messages received and affects accordingly the accounting system.

An accounting server manages a database which stores financial information of parties' accounts such as positions, as well as financial movements such as when users have put funds in escrow with the service provider from their financial institution, received funds on their financial institution's account from the service provider, or been a party to a transaction executed by the service provider.

In the preferred embodiment, software is made available on smartphones by the service provider. The Software is designed to interact with the communication server B.

### The OTP-Swap Method

In a preferred embodiment, the transaction engine is programmed to execute transactions according to FIG. 2. When it receives a message from one of the communication servers, said message being the result of a message received by the communication server from a party, it either creates a new transaction, if none existed, for this party pair; or it evaluates the validity of the request in the context of an existing transaction, if there was one currently on-going.

Based on the current state, the transaction engine takes appropriate action by triggering the actions leading to the next step. These actions can be the sending of messages to one or both of the parties; altering the state of the on-going transaction for this party pair; and/or affecting the records of the accounting server, The OTP-swap mechanism is implemented as different states of a state machine being run by the transaction engine,

The initial state for a transaction to happen is to have a party with a valid account, called party 1, send via either SMS or the dedicated software three elements: a keyword or Graphical User Interface (GUI)-driven information indicating the intention to initiate a payment out; the intended recipient, called party 2, through a uniquely recognized identification such as cell phone number, email address or unique identifier provided by the service provider; and the amount to be sent.

Upon reception of this message, the transaction engine verifies with the accounting server that party has sufficient funds to cover the transaction; and that party 2 has registered successfully with the service-provider.

If so, the engine progresses the state machine to a new state and performs a series of additional actions: It creates a new on-going transaction, registering parties to the transaction, the value being exchanged, as well as a timestamp of when the transaction began. Finally, it generates two One-Time-Passwords (OTPs) and sends one to each party, via either communication server depending on how each party initiated the communication with the service provider. The message to each party also summarizes the details of the proposed transaction: counterparty identity, and amount being sent.

From this state, the state machine can go to several new states, depending on which party replies and the content of the reply. The state machine eventually needs both parties to send back the OTP, provided to the other party, in order for the transaction to continue.

This mechanism forces both parties to establish in-person, oral communication, to exchange the OTPs they have received. This step forces them to clearly identify one another, and to show agreement to the transaction by sharing the received OTP.

At this stage, the state machine is ready to handle several possibilities: either party sends back the expected OTP; either party sends back an incorrect message or OTP: either party cancels the transaction; one party sends back a correct OTP but the other party does not; no further communication is received until the transaction permissible timeframe expires.

As an example, party 2 sends a message that includes the OTP that was provided to party 1. This message is interpreted by the transaction engine in the context of the transaction described above. The engine expected an OTP confirmation from either party; the message is received before the transaction expiration time; the engine confirms that the OTP received from party 2 is the one that was provided to party 1. The message is accepted and the state machine is progressed to the next state, by which the OTP provided to party 2 is expected to be sent by party 1, before the expiration of the transaction timeframe. As the engine progresses to the new state, messages are sent to both parties to inform them of the new state.

The transaction engine would now expect party 1 to send a message with the OTP sent to party 2. As an example, if party 1 sends a message with the wrong code, the transaction engine will increment an error counter for party 1 that is kept as part of the on-going transaction record. Should the counter reach a pre-defined threshold, the transaction engine automatically cancels the transaction as there exists a doubt on one party's willingness to continue the transaction.

When party 1 sends a message with the correct OTP code, the transaction engine performs the usual verifications (transaction not expired, error counter not over the threshold for this party) and moves the state machine to the next step. Messages are sent by the engine to both parties to inform them. The message to party 1 also requests a final confirmation from the party, in order to verify clearly that the party is willing to finalize the transaction before the transaction irrevocably takes place.

According to one embodiment of the invention, the final confirmation step is a secure code received prior to the transaction by party 1 via a secure channel such as a post mail, a message displayed in the secure environment of the software provided on the smartphone, an interactive telephone service, or a secured webpage. The secure code needs to be provided by party 1 to the transaction engine before the expiry of the on-going transaction.

According to another embodiment, the final confirmation step includes a series of questions on the goods being exchanged, additionally to the secure code. These questions can be presented to either party based on the setup that was agreed with the parties prior to the transaction taking place. These questions are intended to verify that the goods conform to specifications agreed by the parties prior to meeting physically.

The transaction engine expects in the first case party 1 to return the expected transaction confirmation code; in the 2^{nd} case either or both parties to additionally answer the questions in conformity with the expected answers, for the engine to move the state machine to the next state.

Once the next state is reached, the transaction engine communicates the details of the transaction to the accounting server and, upon confirmation of the transaction having been reflected, notifies both parties that the transaction took place in an irreversible manner.

According to one embodiment of the invention where party 2 communicates via the SMS channel, an additional piece of information is sent by the service-provider to the party in order for the party to ascertain the identity of the service-provider. By design, SMS messaging can be spoofed and party 2 could be led to believe that he is receiving messages from the service-provider while they are actually sent by an attacker. Therefore, beforehand the service-provider provides party 2 with a security card containing one or several single-use transaction confirmation codes. The security card is sent via a secure channel such as a post mail, a message displayed in the secure environment of the software provided on a smartphone, an interactive telephone service, or a secured webpage. The last confirmation message contains, additionally to the transaction details, one of the single-use transaction codes. Party 2 can, therefore, compare it to the codes received in advance to ascertain the identity of the service-provider as the correct sender of the message.

According to another embodiment, the initial step of initiating the transaction is conducted by the parties using Near Field Communication (NFC) - enabled smartphones to identify the parties to the transaction. This step, known as “NFC-handshake”, simplifies the procedure for party 1 as they do not have to identify manually party 2 to the service-provider any longer.

The foregoing descriptions of embodiments of the invention have been presented for purposes of illustration and description only. They are not intended to be exhaustive or to limit the invention to the forms disclosed. Accordingly, the above disclosure is not intended to limit the invention; the scope of the invention is defined by the appended claims.

1-4. (canceled)

5. A computer-implemented method for securing large monetary transactions over mobile phones and smartphones known as “OTP-swap”, the method comprising:
a. interpreting provided transaction characteristics such as proposed counterparty and proposed transaction amount;
b. recognizing a situation where a trade is possible through matching of client-originating information and previously collected service-provider information;
c. triggering an OTP-swap mechanism if the transaction is plausible;
d. sending of two independent, random OTP codes, one to each of the parties to the transaction, together with the proposed transaction details;
e. parties to the transaction orally exchanging the received OTPs to signify mutual agreement to the transaction, and sending each other's OTP back to the service provider; and
f. recognizing of the OTPs sent back by parties to the transaction within a limited acceptance timeframe and maximum permissible errors.

6. The method according to claim 5, in which the OTP-swap mechanism is implemented as part of a transaction engine and process, the method further comprising the steps of;
a. providing self-led subscription to the system for users through a website hosted by the service provider;
b. preforming regulatory checks, by a service-provider-led business process, in advance of the transaction taking place by which, and results of said process driving the acceptance decision of a client to the system by the provider;
c. residing a computer-implemented transaction engine and database on a server, designed to allow transactions over connected and disconnected, secured or unsecured communication channels, without compromising security; and
d. making the engine available through various communication channels, such as SMS and data-connections (3G/4G, wifi, etc) and able to handle transactions between two parties connected through a different mean.

7. The method according to claim 5, further comprising the step of accomplishing the identification of the parties to the transaction through a direct communication between a service provider's application installed on the mobile phones of the parties using a Near-Field Communication (NFC) channel.

8. The method according to claim 6, further comprising the step of accomplishing the identification of the parties to the transaction through a direct communication between a service provider's application installed on the mobile phones of the parties using a Near-Field Communication (NFC) channel.

9. The method according to claim 5, further comprising the step of augmenting the transaction engine by a capacity to check the compliance of goods sold by the steps of:
a. facilitating self-led agreement between a buyer and a seller, through a website hosted by the service provider, on expected characteristics of goods sold;
b. presenting a series of questions to the seller during the transaction, allowing the seller to confirm quality and compliance of the good being sold in the transaction process, compared to the pre-agreed characteristics list; and
c. by answering the series of questions, the seller engages responsibility with respect to the characteristics of the good sold, and
d. presenting a buyer with the answers, before the OTP-swap, allowing the buyer to inspect the goods.

10. The method according to claim 6, further comprising the step of augmenting the transaction engine by a capacity to check the compliance of goods sold by the steps of:
a. facilitating self-led agreement between a buyer and a seller, through a website hosted by the service provider, on expected characteristics of goods sold;
b. presenting a series of questions to the seller during the transaction, allowing the seller to confirm quality and compliance of the good being sold in the transaction process, compared to the pre-agreed characteristics list, and
c. by answering the series of questions, the seller engages responsibility with respect to the characteristics of the good sold, and
d. presenting a buyer with the answers, before the CTP-swap, allowing the buyer to inspect the goods.

11. The method according to claim 10, further comprising the step of accomplishing the identification of the parties to the transaction through a direct communication between a service provider's application installed on the mobile phones of the parties using a Near-Field Communication (NFC) channel.
